(19) United States
(12) Patent Application Publication
(10) Pub. No.: US 2017/0188527 A1
(43) Pub. Date: Jul. 6, 2017

(54) Self-Watering Planter

(71) Applicant: Jeff Gordon, Hillsboro, OR (US)

(72) Inventor: Jeff Gordon, Hillsboro, OR (US)

(21) Appl. No.: 14/988,031

(22) Filed: Jan. 5, 2016

(51) Int. Cl. A01G 27/00; A01G 1/00; F16L 15/00; A01G 9/02

(52) U.S. Cl. CPC A01G 27/00; A01G 9/021; A01G 9/027; A01G 1/001; A01G 27/008; F16L 15/00

(57) ABSTRACT

A self-watering planter device having an integral internal irrigation system, and method of watering allowing water to be supplied by means of standard garden water hose and existing water faucet. A plurality of said self-watering planters capable of being daisy-chained in a serial configuration to allow a single source of water from a standard water faucet and standard garden water hoses to provide irrigation water to all of said plurality of self-watering planters.

### BACKGROUND OF THE INVENTION

1. Field of the Invention

The present invention relates generally to self-watering devices and, more specifically, to a method and planter apparatus for housing and watering plants providing a container for housing house plants and providing irrigation to the plants housed therein as an integrated unit adaptable to connection to a standard garden water hose.

2. Description of the Related Art

Planters require frequent watering, or else the flowers or other plants therein will quickly wither and die. This is true in moderate as well as hot climates, since such containers hold a relatively small volume of soil and are exposed on all sides, and therefore suffer rapid loss of moisture through evaporation. Moreover, planter boxes are frequently located under eaves, deck coverings, trees or other features that obstruct or limit their access to rain water.

The need for frequent and routine watering places a significant burden on the homeowner or gardener. The burden is especially difficult for persons who are subject to busy work schedules, as well as for the elderly and persons having limited mobility. Moreover, the situation can become acute if the person is absent for a significant period of time—when away on vacation, for example—unless the person can enlist the temporary services of a neighbor, friend or family member to tend to the watering.

These difficulties have, of course, been well known, and a number of solutions have been proposed over the years. While often effective in the sense of being able to achieve a degree of watering, none have represented an entirely satisfactory solution.

Certain of these prior devices have relied on electrically updated valves and controls. This approach has become increasingly common in recent years, however, it remains prohibitively expensive to provide a valve and electric controller for each planter; moreover, to do so would require running not only a water line but also an electrical cord to each and every planter. Certain electrically-operated systems have been developed that employ a central controller and valve assembly from which irrigation tubing is routed to individual destinations, however, this means that a multitude of tubes must be routed from their origin (typically, a garage or basement location) to the various plants

Other automatic watering devices have been developed that do not rely on electrical power for their operation and are therefore free from some of the complications noted above. However, a satisfactory solution has remained elusive.

A few such non-electric devices have relied on structures or materials having physical characteristics that respond in some way to changes in moisture—for example, the swelling of a piece of wood—but as a group such mechanisms exhibit poor reliability and long-term durability. Others have been actuated by changes in height as the amount of water in the container increases/decrease, which offers the prospect of far more reliable operation; however, the mechanisms have generally been deficient for a number of reasons. For example, many of the gravity-operated mechanisms have been excessively complex and/or cumbersome, so that they are too bulky and too expensive to be used with individual planters or boxes, especially where a yard or deck contains a number of planters. The bulky, visually obtrusive appearance of many of these devices also renders them unsatisfactory from an aesthetic standpoint. Moreover, many of the mechanically operated devices are intended to operate in conjunction with an associated reservoir (e.g., a small water tank), which is only a partial solution, since the owner must replenish the reservoir itself on a periodic basis.

A few devices have been developed that take the more effective approach of controlling the flow of water through small-diameter tubing that can be connected to a tap or other pressure source and strung, unobtrusively along a deck railing or other support. However many of these devices require parts that must be machined, cast or molded with very close tolerances making such devices very expensive. Other devices require the use of soft flexible tubing folded to cut off the flow of water and allowed to straighten enough to allow the flow of water to the planter using some sort of spring mechanism. These types of devices, however, in that the need to flatten or flex the rubber tubing is somewhat difficult to achieve fine adjustments.

All of these devices whether electrical or mechanical require separate water lines to each planter and in many cases separate electrical and/or valves or valve controls for each planter also.

One such apparatus meeting these requirements provides irrigation by way of a water dispensing device across a portion of the top of a planter covering a portion of the planter's open top surface area, thus reducing the plantable surface area. Additionally it is, for practical purposes, restricted to rectangular planters.

Accordingly, there exists a need for an apparatus that is both a planter that incorporates the irrigation functionality as an integral part of the planter and which can utilize a standard garden water hose to provide the water and timing apparatus. Further there exists a need for the ability to “daisy-chain” multiple planters together so that only one water line need be provided from a water source to irrigate all of the planters on a deck, a patio, a yard, or combinations thereof. Still further, there exists a need for such an integrated apparatus that is inexpensive to manufacture and that is durable and long-lasting in use. Additionally, there remains a need for such a self-watering device that is not limited in planter geometry.

### SUMMARY OF THE INVENTION

The present invention is directed to providing a planter apparatus of various desired geometric configuration comprising both a plant container and an irrigation system as an integral unit that can be connected to a standard garden water hose to supply water and in which a plurality of such planter apparatus can be daisy-chained together to allow a single water source connection to irrigate all of the plurality of planter apparatus.

More particularly, the invention resides in a planter of various desired geometric configuration with an integral irrigation system that may be set on the ground or patio or deck surface, hung from a deck or other railing, or mounted on a vertical surface such as a wall or post, wherein said planter may be connected to a standard garden water hose for a water source. Most particularly, the present invention resides in a planter having a round geometric configuration with an integral irrigation system not covering any portion of the planting surface area of said planter.

One object of the present invention is providing a planter apparatus of various desired geometric configuration having an integral irrigation system connectable to an existing standard garden water hose without the need for special fittings or modifications of the planter apparatus to accept a water line or irrigation system therein.

Yet another object of the present invention is providing a self-watering planter for watering plants in said planter comprising: a planter container having substantially vertical sides with a distal closed bottom end and a proximal open top end; an integral irrigation system comprising an internal water manifold having a water input female connector and a water exit male connector for connection of standard garden water hose, and a plurality of internal water distribution channels, each of said internal water distribution channels having a distal end connected to said water manifold and a proximal end having at least one water outlet orifice; thereby providing a self-water planter having an integral water irrigation system contained therein through which water may be supplied by a single water source by means of a standard garden water hose.

Still another object of the present invention is providing a plurality of self-watering planters for watering plants in said plurality of self-watering planters from a single water source by means of connecting said plurality of self-watering planters to each other in a serial daisy-chain configuration, each of said plurality of self-watering planters comprising: a planter container having substantially vertical sides with a distal closed bottom end and a proximal open top end; an integral irrigation system comprising an internal water manifold having a water input female connector and a water exit male connector for connection of standard garden water hose, and a plurality of internal water distribution channels, each of said internal water distribution channels having a distal end connected to said water manifold and a proximal end having at least one water outlet orifice; thereby providing a self-water planter having an integral water irrigation system contained therein through which water may be supplied by a single water source by means of a standard garden water hose.

Yet still another object of the present invention is providing a method of watering plants contained in a plurality of self-watering planters utilizing a single water source and common standard garden water hose to provide water to all of said self-watering planters.

Beneficial effects of the present invention include the ability to use existing water faucets, and common garden hose to provide irrigation water to one or more of the claimed self-watering planters as well as to allow for easy and economical connection of said one or more self-watering planters to an existing lawn/garden watering system. Additional benefits include saving water, prevention of non-desired growth within and without the self-watering planter, and the inconvenience of water getting on structures and/or furniture as common with the use of conventional sprinklers.

A complete understanding of the present invention may be obtained from the drawings and detailed description that follow.

### BRIEF DESCRIPTION OF THE DRAWINGS

FIG. 1 shows a perspective side view of a preferred embodiment of the present invention showing a self-watering planter including the planter body, water manifold connections, and the water outlet orifices.

FIG. 2 shows a sectional view of FIG. 1 through section line A-A showing the water manifold integral to the planter body including the water manifold connections, the planter body sides, the planter body bottom with optional drainage orifice.

FIG. 3 show a top perspective view of a preferred embodiment of the present invention showing the planter body sides, bottom with optional drainage orifice, water manifold, and water distribution channels with water outlet orifices.

FIG. 4 shows a sectional side view of FIG. 3 through section line B-B showing the planter body sides, planter body bottom, water manifold with water connection orifice, water distribution channels with water outlet orifices.

FIG. 5 shows a plurality of planters of the present invention connected in series to allow one water line to provide water to all of them.

### DESCRIPTION OF THE PREFERRED EMBODIMENTS OF THE INVENTION

This invention was developed to provide an efficient and aesthetically pleasing method of irrigating a planter of various desired geometric configuration or plurality of planters of various desired geometric configuration requiring only a single common standard garden water hose to provide the water to all of the planters no matter the number. In addition, it was developed to allow for easy automatic planter irrigation on decks, patios, and landscaping using the available water facet and/or lawn watering system without the need for separate water and/or electrical lines to each planter.

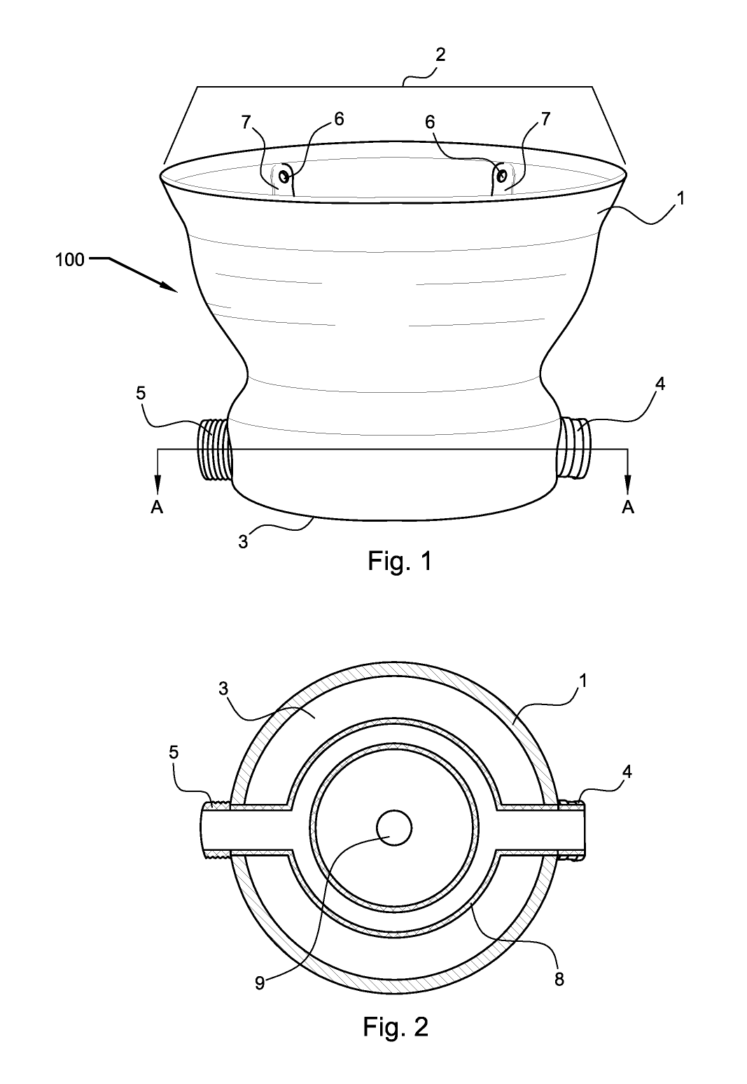

Turning to FIG. 1, shown therein is an illustrative perspective side view of self-watering planter 100 of the present invention; comprising planter container sides 1 having a proximal (top) open end 2, distal (bottom) end 3, an integral water manifold 8 (see FIG. 2) water intake 4, and water exit 5. Also shown are integral water distribution channels 7 having water distribution orifices 6.

FIG. 2 shows a sectional plan view through section line A-A of FIG. 1 showing the planter container 1, container bottom end 3 with optional drainage orifice 9. Also shown is water intake 4, and water exit 5 both connected to integral water manifold 8.

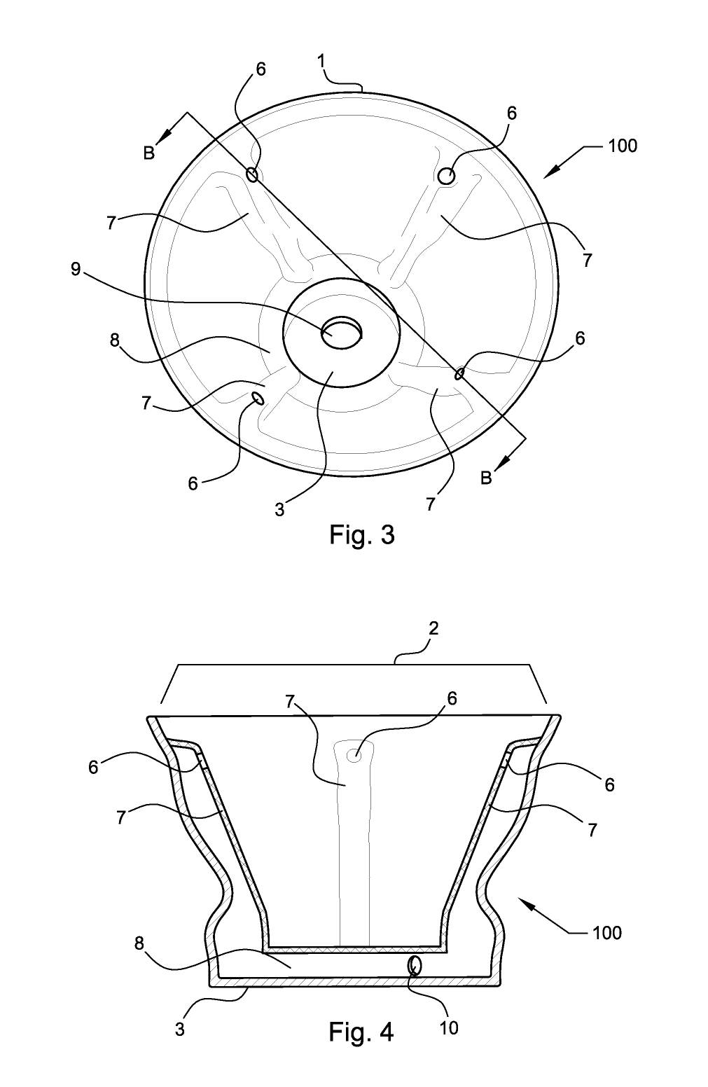

FIG. 3 shows an illustrative perspective top view of self-watering planter 100 of the present invention; comprising planter container sides 1 as viewed through the proximal (top) open end 2 showing distal (bottom) end 3 with an optional drainage orifice 9, an integral water manifold 8 with integral water distribution channels 7 having water distribution orifices 6.

Turning now to FIG. 4, shows a sectional plan view through section line B-B of FIG. 3 showing self-watering planter 100 having open proximal (top) end 2, distal (bottom) end 3, integral water manifold 8, integral water distribution channels 7 having water distribution orifices 6, and water intake orifice 10.

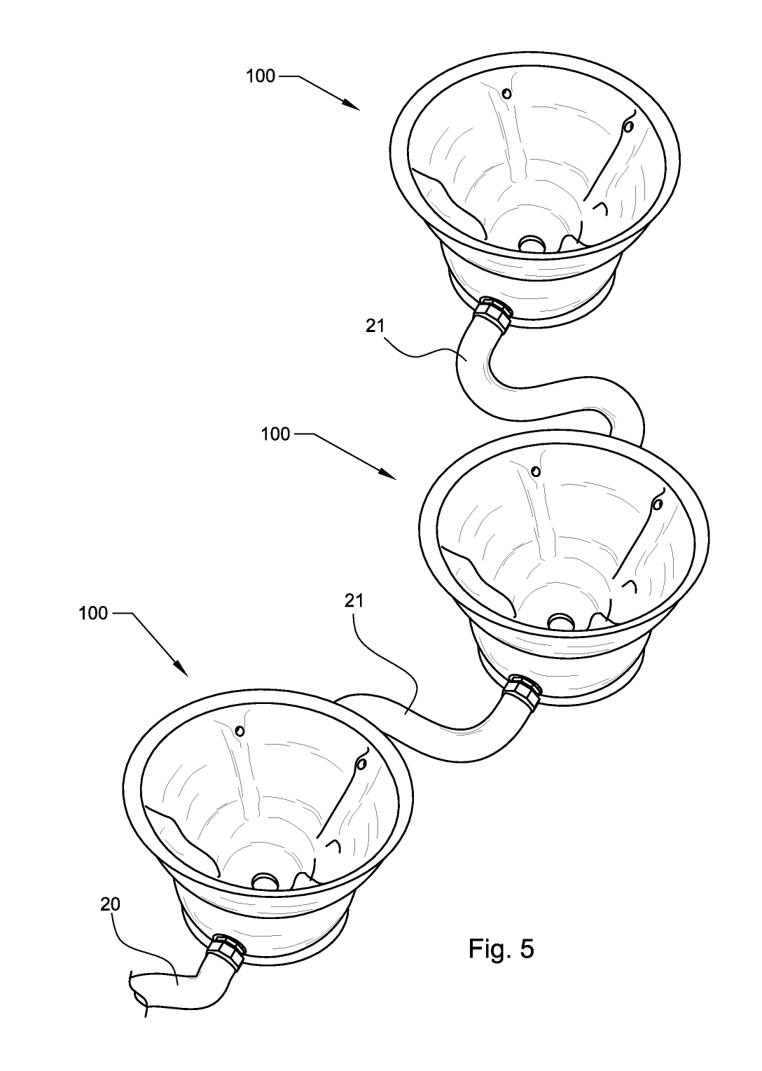

Finally FIG. 5 shows a perspective view of a plurality of the self-watering planters 100 of the present invention connected in series (“daisy-chained”) together using connecting hoses 21 to allow a single water supply hose 20 to provide water to all of the plurality of said planters 100. It is to be appreciated that the self-watering planters of the present invention may also be connected in parallel or in any combination of series and parallel using appropriate water line configurations as are well known in the art. It is to be appreciated that the second end of the last self-watering planter of the present invention in the watering series may be left open to allow water to flow out or may be capped using a standard terminal end cap well known in the art to seal the watering system.

The use of the term “of various desired geometric configuration” and the like includes various planter shapes and/or styles such as, for example, circular, oval, and rectangular, as are well known in the art.

The use of the term “standard garden water hose” and the like includes garden water hose, and other lawn and garden irrigation piping and hose commonly sold for such uses and which is well known in the art such as, for example, standard PVC plumbing, standard ABS plumbing, low pressure poly rolled irrigation pipe, and combinations thereof. The means of connecting said well-known water supply means also being well known in the art such as, for example, slip/glue fittings, threaded fittings, compression fittings, and barbed plastic fittings.

Additionally, the self-watering planters of the present invention can be used on the same water supply system as other devices such as sprinklers, soakers, and the like as are well known in the art.

In one presently preferred embodiment all of the planter having integral water manifold system of the present invention are formed by injection molding, however other methods for forming the various parts such as, for example, extrusion, and machining, are also contemplated. All of the various parts may be constructed of the same material or of various different materials within the knowledge of those skilled in art.

In another presently preferred embodiment the planter of the claimed invention are formed of pottery using methods of production well known in the art.

Although the preferred embodiments of the present invention have been disclosed, various changes and modifications may be made without departing from the scope of the invention as set forth in the appended claims.

What is claimed is:

1. A self-watering planter for watering plants in said planter comprising:
a) a planter container having substantially vertical sides with a distal closed bottom end and a proximal open top end;
b) an integral irrigation system comprising an internal water manifold having a water input female connector and a water exit male connector for connection of standard garden water hose, and a plurality of internal water distribution channels, each of said internal water distribution channels having a distal end connected to said water manifold and a proximal end having at least one water outlet orifice,
thereby providing a self-water planter having an integral water irrigation system contained therein through which water may be supplied by a single water source by means of a standard garden water hose.

2. The self-watering planter as claimed in claim 1 wherein, said planter container distal closed bottom end has at least one drainage orifice.

3. The self-watering planter as claimed in claim 1 wherein, said female end of said irrigation tube is fixedly attached to said internal water manifold.

4. The self-watering planter as claimed in claim 1 wherein, said female end is rotatably attached to said internal water manifold.

5. The self-watering planter as claimed in claim 1 wherein, said standard garden water hose is selected from the group comprising; flexible water hose, flexible lawn and garden irrigation pipe, substantially rigid lawn and garden irrigation pipe, and combinations thereof.

6. The self-watering planter as claimed in claim 1 wherein, said planter container is made of pottery material.

7. The self-watering planter as claimed in claim 1 wherein, said planter container is made of a plastic material.

8. A plurality of self-watering planters for watering plants in said plurality of self-watering planters from a single water source by means of connecting said plurality of self-watering planters to each other in a serial daisy-chain configuration, each of said plurality of self-watering planters comprising:
a) a planter container having substantially vertical sides with a distal closed bottom end and a proximal open top end;
b) an integral irrigation system comprising an internal water manifold having a water input female connector and a water exit male connector for connection of standard garden water hose, and a plurality of internal water distribution channels, each of said internal water distribution channels having a distal end connected to said water manifold and a proximal end having at least one water outlet orifice;
thereby providing a self-water planter having an integral water irrigation system contained therein through which water may be supplied by a single water source by means of a standard garden water hose.

9. The self-watering planter as claimed in claim 8 wherein, said female end of said irrigation tube is fixedly attached to said internal water manifold.

10. The self-watering planter as claimed in claim 8 wherein, said female end is rotatably attached to said internal water manifold.

11. The self-watering planter as claimed in claim 8 wherein, said standard garden water hose is selected from the group comprising; flexible water hose, flexible lawn and garden irrigation pipe, substantially rigid lawn and garden irrigation pipe, and combinations thereof.

12. The self-watering planter as claimed in claim 8 wherein, said planter container distal closed bottom end has at least one drainage orifice.

13. The method of watering plants contained in a plurality of self-watering planters utilizing a single water source and standard garden water hose to provide water to all of said self-watering planters.

14. The method of watering plants contained in a plurality of self-watering planters utilizing a single water source and standard garden water hose to provide water to all of said self-watering planters as claimed in claim 13 wherein, the water exit male connector of the last of said plurality of self-watering planter is sealed with a terminal end cap.
